(19) United States
(12) Patent Application Publication
(10) Pub. No.: US 2026/0163520 A1
(43) Pub. Date: Jun. 11, 2026

(54) SOLAR ENERGY SYSTEM AND METHOD FOR TRANSFERRING SUNLIGHT FROM A SUNLIGHT COLLECTION LOCATION TO A REMOTE SUNLIGHT DISTRIBUTION LOCATION FOR PHOTOVOLTAIC EFFECT

(71) Applicant: Devang L Bhalgama, Indian Land, SC (US)

(72) Inventor: Devang L Bhalgama, Indian Land, SC (US)

(21) Appl. No.: 18/723,991

(22) PCT Filed: Jun. 5, 2024
(86) PCT No.: PCT/US2024/032532

§ 371 Date: Jun. 25, 2024

Related U.S. Application Data
(60) Provisional application No. 63/523,605, filed on Jun. 27, 2023.

(51) Int. Cl. H02S 40/22; G02B 6/36

(52) U.S. Cl. CPC H02S 40/22; G02B 6/3672

(57) ABSTRACT

A solar energy system is configured to transfer sunlight from a sunlight collection location to a remote sunlight distribution location for photovoltaic effect. The solar energy system includes a bundled array of fiber optic cables, at least one cable pegboard, and at least one solar panel. The cable pegboard is arranged at the remote sunlight distribution location. Micro-connectors on the pegboard secure and orient respective end facets of the fiber optic cables at respective transmitting ends. The solar panel resides adjacent the cable pegboard at the sunlight distribution location, and is optically arranged to receive sunlight transferred from the sunlight collection location through the bundled array of fiber optic cables for photovoltaic effect.

### TECHNICAL FIELD AND BACKGROUND OF THE DISCLOSURE

The present disclosure relates broadly and generally to a solar energy system and method for transferring sunlight from a sunlight collection location to a remote sunlight distribution location for photovoltaic effect.

Conventional solar energy systems utilize multiple solar panels and require substantial space on rooftops, land and other surface areas exposed to the sun. Presently, there is no practical solution to effectively and efficiently generate a comparable amount of solar energy while requiring only a fraction of the exposed surface area needed for sun collection.

### SUMMARY OF EXEMPLARY EMBODIMENTS

Various exemplary embodiments of the present disclosure are described below. Use of the term “exemplary” means illustrative or by way of example only, and any reference herein to “the invention” is not intended to restrict or limit the invention to exact features or steps of any one or more of the exemplary embodiments disclosed in the present specification. References to “exemplary embodiment,” “one embodiment,” “an embodiment,” “various embodiments,” and the like, may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

It is also noted that terms like “preferably”, “commonly”, and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

According to one exemplary embodiment, the present disclosure comprises a solar energy system configured to transfer sunlight from a sunlight collection location to a remote sunlight distribution location for photovoltaic effect. The solar energy system includes a bundled array of fiber optic cables, at least one cable pegboard, and at least one solar panel. Each of the fiber optic cables has a receiving end optically arranged at the sunlight collection location and a transmitting end optically arranged at the sunlight distribution location. The cable pegboard is arranged at the sunlight distribution location, and comprises a plurality of spaced apart micro-connectors at respective through-holes defined by the pegboard. The micro-connectors secure and orient respective end facets of the fiber optic cables at the transmitting end of the bundled array. The solar panel resides adjacent the cable pegboard at the sunlight distribution location, and is optically arranged to receive sunlight transferred from the sunlight collection location through the bundled array of fiber optic cables for photovoltaic effect.

As generally known and understood in the art, photovoltaic effect occurs when photons from the transferred sunlight hit the semiconductive material (typically silicon) in the PV cell of the solar module. The photons activate electrons, causing them to free themselves from the semiconductive material. The free electrons flow through the solar cells, down wires along the edge of the panel, and into a combiner box —as described in the example below.

The term “pegboard” is broadly defined herein to mean any board, panel, polymer or fabric sheet, or other comparable structure defining through-holes configured to secure and space end facets of fiber optic cables.

The term “micro-connector” refers broadly herein to any miniaturized optical connector or other connection component configured to secure and orient the end facet of fiber optic cable. In one example, the micro-connector comprises a MU connector with a compact push-pull design. In another example, the micro-connectors and pegboard are integrally formed together as a single homogenous unit.

According to another exemplary embodiment, a sunlight concentrator is optically coupled to receiving ends of the fiber optic cables at the sunlight collection location.

According to another exemplary embodiment, the sunlight concentrator comprises a plurality of micro-lenses optically aligned with (e.g., integrated on) respective end facets of the fiber optic cables.

According to another exemplary embodiment, the receiving ends of the fiber optic cables are held together and carried by a collection frame at the sunlight collection location.

According to another exemplary embodiment, a solar tracker operatively engages the collection frame and is adapted to (automatically) orient the receiving ends of the fiber optic cables towards the sun.

According to another exemplary embodiment, the solar tracker comprises a plurality of linear actuators designed to selectively lift and lower respective sides of the collection frame.

According to another exemplary embodiment, the cable pegboard has an input face for receiving end facets of the fiber optic cables and an output face from which sunlight projects onto the solar panel.

According to another exemplary embodiment, the micro-connectors of the cable pegboard are sufficiently spaced apart to project sunlight onto greater than 75 percent of an adjacent PV surface area of the solar panel.

According to another exemplary embodiment, the micro-connectors of the cable pegboard are sufficiently spaced apart to project sunlight onto substantially an entire adjacent PV surface area of the solar panel.

According to another exemplary embodiment, a plurality of micro-lenses are optically aligned with (e.g., integrated on) end facets of the fiber optic cables at the sunlight distribution location.

According to another exemplary embodiment, the bundled array comprises greater than 30,000 individual fiber optic cables. In this example, the bundled cables at the sunlight collection location has a dimension of less than one square foot.

According to another exemplary embodiment, the cable peg board comprises greater than 3,000 spaced apart micro-connectors. Each micro-connector secures and orients a plurality of fiber optic cables.

In another exemplary embodiment, a solar energy system of the present disclosure is configured to transfer sunlight from a sunlight collection location to a remote sunlight distribution location for photovoltaic effect. The solar energy system includes a bundled array of fiber optic cables, a plurality of cable pegboards and a plurality of solar panels. Each fiber optic cable has a receiving end optically arranged at the sunlight collection location and a transmitting end optically arranged at the sunlight distribution location. The plurality of cable pegboards are arranged at the sunlight distribution location. Each cable pegboard has an input face for receiving, spacing and orienting end facets of the fiber optic cables, and an output face from which sunlight projects. The plurality of solar panels reside adjacent the cable pegboards at the sunlight distribution location, and are optically arranged to receive sunlight transferred from the sunlight collection location through the bundled array of fiber optic cables for photovoltaic effect.

According to another exemplary embodiment, first and second adjacent cable pegboards are arranged input face to input face, such that the output faces of the cable pegboards project sunlight in opposite directions.

According to another exemplary embodiment, first and second solar panels are optically arranged to face respective output faces of the first and second cable pegboards.

In one example, each cable peg board has an approximate dimension of 74 inches×41 inches with micro-connectors uniformly spaced apart 1.0 inches. In this example, each solar panel has a PV surface area of approximately 74 inches×41 inches to reside in substantial registration with the output face of the pegboard.

In yet another exemplary embodiment, the present disclosure comprises a method for transferring sunlight from a sunlight collection location to a remote sunlight distribution location for photovoltaic effect. The method includes bundling an array of fiber optic cables, each cable having a sunlight receiving end and a sunlight transmitting end. The receiving ends of fiber optic cables are optically arranged at the sunlight collection location. The transmitting ends of fiber optic cables are mounted to a cable pegboard arranged at the sunlight distribution location. A solar panel is optically arranged relative to the cable pegboard to receive sunlight transferred from the sunlight collection location through the bundled array of fiber optic cables for photovoltaic effect.

### BRIEF DESCRIPTION OF THE DRAWINGS

Exemplary embodiments of the present disclosure will hereinafter be described in conjunction with the following drawing figures, wherein like numerals denote like elements, and wherein:

FIG. 1 is a view of the exemplary solar energy system incorporated in residential building;

FIG. 2 is a diagrammatic view illustrating movement of sunlight from a sunlight collection location to a remote sunlight distribution location;

FIG. 3 is an exploded perspective view showing the bundled receiving ends of fiber optic cables and the solar tracker at the sunlight collection location;

FIG. 4 is a side view of the solar tracker demonstrating operation of the linear actuators for tilt adjustment;

FIG. 5 is a diagrammatic view of the solar energy system according to one exemplary application; and

FIG. 6 is a diagrammatic view of a solar energy system according to a further exemplary embodiment of the present disclosure.

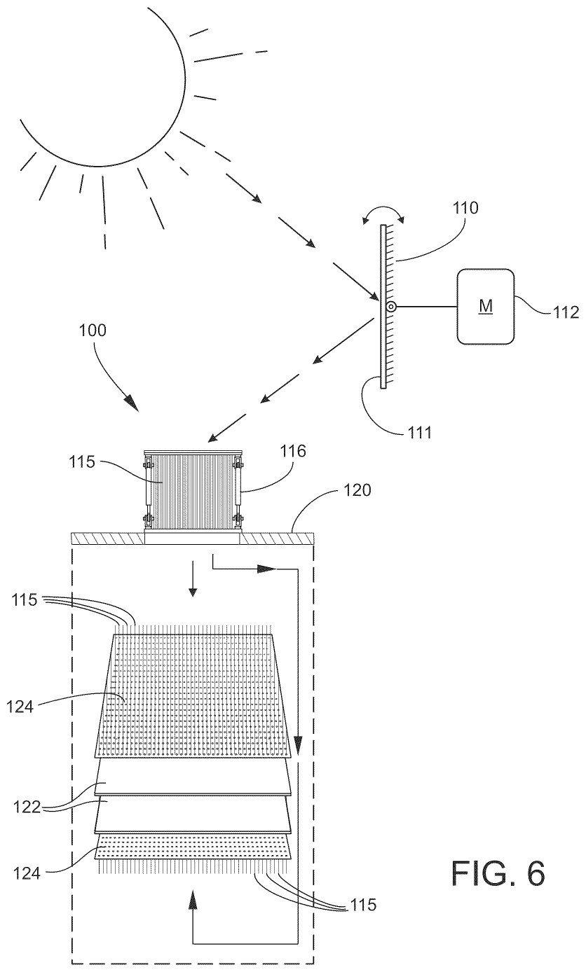

### DESCRIPTION OF EXEMPLARY EMBODIMENTS AND BEST MODE

The present invention is described more fully hereinafter with reference to the accompanying drawings, in which one or more exemplary embodiments of the invention are shown. Like numbers used herein refer to like elements throughout. This invention may, however, be embodied in many different forms and should not be construed as limited to the embodiments set forth herein; rather, these embodiments are provided so that this disclosure will be operative, enabling, and complete. Accordingly, the particular arrangements disclosed are meant to be illustrative only and not limiting as to the scope of the invention, which is to be given the full breadth of the appended claims and any and all equivalents thereof. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at least one of the items, but does not exclude a plurality of items of the list.

For exemplary methods or processes of the invention, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Additionally, any references to advantages, benefits, unexpected results, or operability of the present invention are not intended as an affirmation that the invention has been previously reduced to practice or that any testing has been performed. Likewise, unless stated otherwise, use of verbs in the past tense (present perfect or preterit) is not intended to indicate or imply that the invention has been previously reduced to practice or that any testing has been performed.

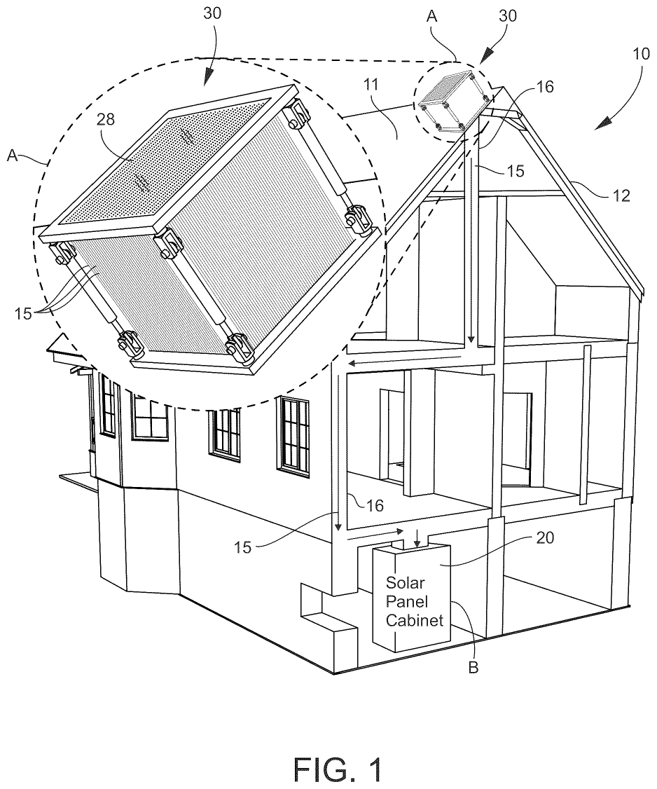

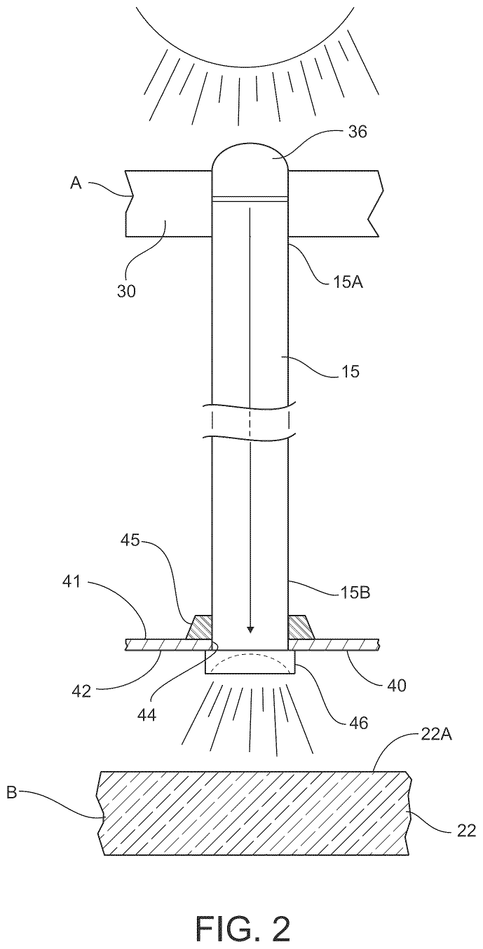

Referring now specifically to the drawings, a solar energy system according to one exemplary embodiment of the present disclosure is illustrated in FIG. 1 and shown generally at broad reference numeral 10. The present system 10 is configured to transfer sunlight from a sunlight collection location “A”, such as the exterior roof 11 of a residential building 12, to a remote sunlight distribution location “B” for photovoltaic effect. Concentrated sunlight is forwarded in collimated waveguides using a bundled array of flexible fiber optic cables 15 (e. g, 30000 or more, 1.5 mm cables) passed through building conduit 16, and extending continuously from the sunlight collection location “A” to the remote sunlight distribution location “B”. As shown in FIG. 2, each fiber optic cable 15 has a receiving end 15A optically arranged at the sunlight collection location “A” and a transmitting end 15B optically arranged at the sunlight distribution location “B”. In the example shown, the sunlight distribution location “B” comprises a solar panel cabinet 20 situated in a basement of the building 12. In other examples, the present system 10 may utilize multiple solar panel cabinets 20 at different sunlight distribution locations “B” both inside and outside the building 12. As described further below, each cabinet 20 houses a number of stacked solar panels 22 optically arranged to receive sunlight from transmitting ends 15B of the fiber optic cables 15.

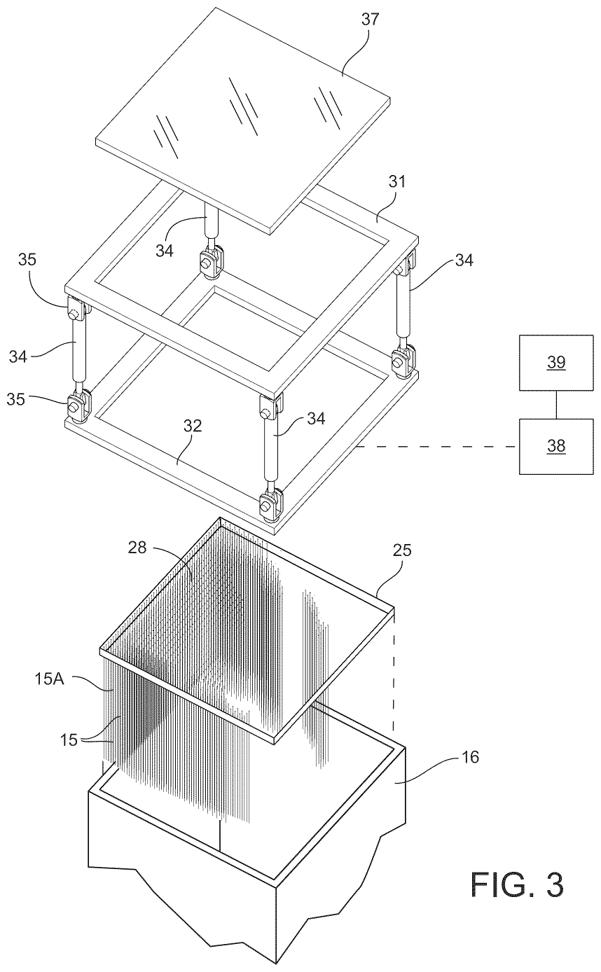

Referring to FIGS. 1, 3 and 4, the bundled array of fiber optic cables 15 extends from the conduit 16 proximate the exterior roof 11 of the building 12 to the sunlight collection location “A”. Receiving ends 15A of cable 15 are tightly held together by one or more straps 25 or other suitable bindings, and are precisely aligned and arranged such that individual end facets collectively form a substantially continuous optical surface area 28 at the sunlight collection location “A”. The bundled receiving ends 15A are carried by a solar tracker 30 mounted to the roof 11. The exemplary solar tracker 30 incorporates an adjustable frame assembly having top and bottom square frame members 31, 32 operatively interconnected at respective corners by electronic (or hydraulic) linear actuators 34. Each actuator 34 is attached to the frame members 31, 32 by universal joints 35. The bundled receiving ends 15A of fiber optic cable are held together and carried by the solar tracker 30 at the sunlight collection location “A” such that the optical surface area 28 defined by the end facets occupies substantially the entire square space defined by the top frame member 31. In one example, both the top and bottom frame members 31, 32 are approximately 1 ft×1 ft, or one square foot. For improved efficiency, micro-lenses 36 or other solar concentrator may be optically coupled to (or integrated on) ends 15A of fiber optic cables 15. See FIG. 2. A protective glass cover 37 extends over the top frame member 31 to shield the fiber optic cables 15 from dust, debris, moisture, rain and other environmental elements.

The solar tracker 30 operates in a conventional manner, and incorporates known elements including a controller 38 and light sensors 39 to detect the position of the sun in the sky. The controller 38 processes information received from the sensors 39 and calculates the optimal angle and orientation of the optical surface area 28 defined by the bundled fiber optic cables 15. The controller 38 then sends signals to the corner actuators 34 to mechanically tilt the top frame member 31 towards the sun, and thereafter continuously adjust to follow the movement of the sun across the sky. This maximizes the amount of sunlight that the fiber optic cables 15 receive at the sunlight collection location “A”. Tracking algorithms may also be used to predict the movement of the sun throughout the day.

From the rooftop solar tracker 30 at the sunlight collection location “A”, the bundled array of fiber optic cables 15 travels through interior conduit 16 to the solar panel cabinet 20 situated in the basement of the building 12 at the remote sunlight distribution location “B”. Although only a single sunlight collection location “A” and sunlight distribution location “B” are shown, it is understood that the exemplary system 10 may utilize any number of bundled arrays of fiber optic cables 15 at multiple different locations both inside and outside the building 12.

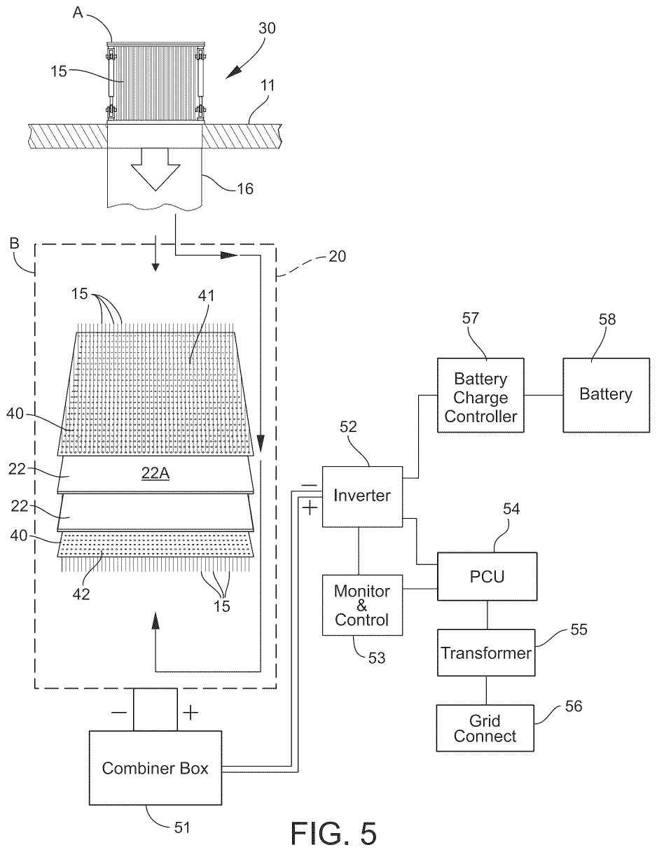

As best illustrated in FIGS. 1, 2 and 5, fiber optic cables 15 enter the solar panel cabinet 20 and respective transmitting ends 15B and extend to spaced apart, horizontally disposed cable pegboards 40. Each cable pegboard 40 has an input face 41 for receiving, spacing and orienting end facets of the fiber optic cables 15, and an output face 42 from which sunlight projects. In exemplary embodiments, the output face 42 comprises a reflective material. A single pegboard 40 may define 3000 or more through-holes 44 in rank and file formation, uniformly spaced apart across an entire surface area of the pegboard 40. In one example, the through-holes 44 are spaced apart between 0.5 inch and 1.0 inch. Micro-connectors 45 (FIG. 2) are located at each through-hole 44 of the pegboard 40, and each micro-connector 45 is designed to secure and orient end facets of one or more fiber optic cables 15. The fiber optic cables 15 at each pegboard through-hole 44 may optically connect to respective micro-lenses 46 designed to disperse sunlight. A single micro-lens 46 may be integrated at each through-hole 44; or alternatively, at the end facet of each fiber optic cable 15.

Solar panels 22 reside inside cabinet 20 adjacent the cable pegboards 40, and are optically arranged back-to-back (backsheet-to-backsheet) such that their PV sides 22A substantially align in stacked registration with output faces 42 of the cable pegboards 40. The solar panels 22 receive sunlight transferred from the sunlight collection location “A” through the bundled array of fiber optic cables 15 for photovoltaic effect within the solar panel cabinet 20. In one example, the micro-connectors 45 of the cable pegboard are sufficiently spaced apart such that transmitting ends 15B of fiber optic cables 15 project sunlight onto greater than 75 percent of the entire photovoltaic (PV) surface area 22A of the solar panel 22. In another example, the micro-connectors 45 are spaced apart such that transmitting ends 15B of fiber optic cables 15 project sunlight onto substantially the entire PV surface area 22A of the solar panel 22. Both the pegboard 40 and solar panel 22 have an exemplary dimension of approximately 74 inches×41 inches, although any other sizes may be utilized in the present system 10.

In one exemplary embodiment, the present solar energy system 10 utilizes conventional solar panels 22 comprising solar cells that are wired together and held in place by a backsheet, frame, and a pane of glass. The solar cells may be monocrystalline or polycrystalline. The top layer of each solar panel 22 is made of silicon, and has two main sublayers: a phosphorus-diffused layer on top, and a boron-doped layer on the bottom. The top layer carries electrons and is negatively charged, while the bottom layer contains holes and is positively charged. The top of each solar panel 22 may also include an anti-reflective film to make the panel more efficient. The opposing outermost layer of the solar panel 22 is commonly referred to as the “backsheet.” In another exemplary embodiment, the solar energy system 10 utilizes double-sided solar panels - commonly referred to “bifacial modules.” Each double-sided panel has PV cells on both sides.

### Exemplary Implementation

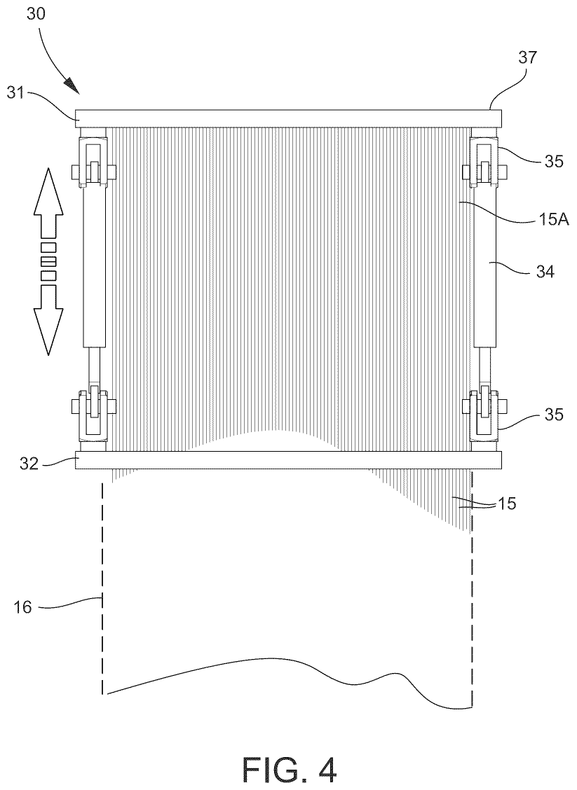

Referring again to FIGS. 1 and 4, in a 2500 square foot residential building 12, 42000 individual fiber optic cables 15 are bundled together and held by exemplary solar tracker 30 at the sunlight collection location “A” atop the roof 11. As previously described, the array of fiber optic cables 15 passes from the roof 11 through conduit 16 to the solar panel cabinet 20 situated at the remote sunlight distribution location “B” (e.g., basement of the building 12). The solar panel cabinet 20 houses 13 solar panels 22 and 13 cable pegboards 40—all closely-spaced, horizontally stacked and aligned.

The solar panels 22 operatively connect to a combiner box 51, which combines the output of numerous strings of PV modules for connection to a solar inverter 52. The inverter 52 changes direct current (DC) electricity generated by solar panels 22 into alternating current (AC) electricity. The inverter 52 connects to a electricity monitoring and control unit 53. In one scenario, AC electricity is directed from the inverter 52 to a power continuity unit 54, transformer 55 and grid connection 56. The electricity runs through an electrical panel and is distributed throughout the building 12—just like grid energy. In a second scenario, electricity from the inverter 52 runs to a battery charge controller 57 to battery 58 for storage.

In other embodiments, the present solar energy system 10 may be utilized in other environments and applications. For example, the present solar energy system 10 may be utilized in solar farms to enable more cost-effective and efficient generation of energy. Traditional solar farms often require a significant open land for mounting hundreds of thousands of solar panels. The present system 10 would enable comparable solar energy production while utilizing only a small fraction of the land space. Locating the solar panels inside the enclosed protective (and watertight) cabinet also reduces panel maintenance and cleaning costs. In other exemplary embodiments, bundled fiber optic cables at various sun collection locations may run to remote solar panel cabinets located underwater, throughout dense forests, or within highly populated cities. The sun collection and sun distribution locations in the present system 10 may be only several feet to many miles apart.

In a further alternative embodiment, the present solar energy system 100 utilizes a solar tracker 110 comprising a reflective surface 111 adjustably tilt-oriented by programmable motor 112 to reflect sunlight into the receiving ends of said fiber optic cables 115 at the sunlight collection location. Individual fiber optic cables 115 are bundled together, and may be held by a second solar tracker 116 mounted atop a solar panel cabinet 120. The solar panel cabinet 120 houses multiple solar panels 122 and cable pegboards 124—all closely-spaced, horizontally stacked and aligned, and operable, as described above. The exemplary cabinet 120 may be located above or below ground at a solar farm, solar park, power plant or other such facility.

For the purposes of describing and defining the present invention it is noted that the use of relative terms, such as “substantially”, “generally”, “approximately”, and the like, are utilized herein to represent an inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Exemplary embodiments of the present invention are described above. No element, act, or instruction used in this description should be construed as important, necessary, critical, or essential to the invention unless explicitly described as such. Although only a few of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention as defined in the appended claims.

In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Unless the exact language “means for” (performing a particular function or step) is recited in the claims, a construction under 35 U.S.C. § 112(f) [or 6th paragraph/pre-AIA] is not intended. Additionally, it is not intended that the scope of patent protection afforded the present invention be defined by reading into any claim a limitation found herein that does not explicitly appear in the claim itself.

What is claimed:

1. A solar energy system configured to transfer sunlight from a sunlight collection location to a remote sunlight distribution location for photovoltaic effect, said solar energy system comprising:
a bundled array of fiber optic cables having a receiving end optically arranged at the sunlight collection location and a transmitting end optically arranged at the sunlight distribution location;
a cable pegboard arranged at the sunlight distribution location and comprising a plurality of spaced apart micro-connectors at respective through-holes for securing and orienting end facets of said fiber optic cables at the transmitting end of said bundled array; and
a solar panel adjacent said cable pegboard at the sunlight distribution location, and optically arranged to receive sunlight transferred from the sunlight collection location through said bundled array of fiber optic cables for photovoltaic effect.

2. The solar energy system according to claim 1, and comprising a sunlight concentrator optically coupled to receiving ends of said fiber optic cables at the sunlight collection location.

3. The solar energy system according to claim 2, wherein said sunlight concentrator comprises a plurality of micro-lenses optically aligned with respective end facets of said fiber optic cables.

4. The solar energy system according to claim 1, wherein receiving ends of said fiber optic cables are held together and carried by a collection frame at the sunlight collection location.

5. The solar energy system according to claim 1, and comprising a solar tracker operatively engaging said collection frame and adapted to orient the receiving ends of said fiber optic cables towards the sun.

6. The solar energy system according to claim 5, wherein said solar tracker comprises a plurality of linear actuators adapted to selectively lift and lower respective sides of said collection frame.

7. The solar energy system according to claim 1, and comprising a solar tracker having a reflective surface adjustably mounted to reflect sunlight into the receiving ends of said fiber optic cables at the sunlight collection location.

8. The solar energy system according to claim 1, wherein said cable pegboard has an input face for receiving end facets of said fiber optic cables and an output face from which sunlight projects onto said solar panel.

9. The solar energy system according to claim 8, wherein said micro-connectors of said cable pegboard are sufficiently spaced apart to project sunlight onto greater than 75 percent of an adjacent surface area of said solar panel.

10. The solar energy system according to claim 8, wherein said micro-connectors of said cable pegboard are sufficiently spaced apart to project sunlight onto substantially an entire adjacent surface area of said solar panel.

11. The solar energy system according to claim 1, and comprising a plurality of micro-lenses optically aligned with end facets of said fiber optic cables at the sunlight distribution location.

12. The solar energy system according to claim 1, wherein said bundled array comprises greater than 30,000 fiber optic cables.

13. The solar energy system according to claim 1, wherein said cable peg board comprises greater than 3,000 spaced apart micro-connectors, and wherein each micro-connector secures and orients at least one fiber optic cable.

14. A solar energy system configured to transfer sunlight from a sunlight collection location to a remote sunlight distribution location for photovoltaic effect, said solar energy system comprising:
a bundled array of fiber optic cables having a receiving end optically arranged at the sunlight collection location and a transmitting end optically arranged at the sunlight distribution location;
a plurality of cable pegboards arranged at the sunlight distribution location, each cable pegboard having an input face for receiving, spacing and orienting end facets of said fiber optic cables at the transmitting end of said bundled array, and an output face from which sunlight projects; and
a plurality of solar panels adjacent said cable pegboards at the sunlight distribution location, and optically arranged to receive sunlight transferred from the sunlight collection location through said bundled array of fiber optic cables for photovoltaic effect.

15. The solar energy system according to claim 14, wherein first and second adjacent cable pegboards are arranged input face to input face, such that the output faces of said cable pegboards project sunlight in opposite directions.

16. The solar energy system according to claim 14, wherein first and second solar panels are arranged to face respective output faces of said first and second cable pegboards.

17. The solar energy system according to claim 14, wherein said bundled array comprises greater than 30,000 fiber optic cables.

18. The solar energy system according to claim 14, wherein said cable peg board comprises greater than 3,000 spaced apart micro-connectors, and wherein each micro-connector secures and orients at least one fiber optic cable.

19. The solar energy system according to claim 14, wherein the receiving ends of said fiber optic cables are held together and carried by a collection frame at the sunlight collection location.

20. The solar energy system according to claim 19, and comprising a solar tracker operatively engaging said collection frame and adapted to orient the receiving ends of said fiber optic cables towards the sun.

21. The solar energy system according to claim 14, and comprising a solar tracker having a reflective surface adjustably mounted to reflect sunlight into the receiving ends of said fiber optic cables at the sunlight collection location.

22. A method for transferring sunlight from a sunlight collection location to a remote sunlight distribution location for photovoltaic effect, said method comprising:
bundling an array of fiber optic cables each cable having a sunlight receiving end and a sunlight transmitting end;
optically arranging the receiving ends of fiber optic cables at the sunlight collection location;
mounting the transmitting ends of fiber optic cables to a cable pegboard arranged at the sunlight distribution location; and
optically arranging a solar panel relative to the cable pegboard to receive sunlight transferred from the sunlight collection location through said bundled array of fiber optic cables for photovoltaic effect.
